(19) United States
(12) Patent Application Publication
(10) Pub. No.: US 2017/0363762 A1
(43) Pub. Date: Dec. 21, 2017

(54) METHOD AND SYSTEM FOR THE DETECTION OF CONDUCTIVE OBJECTS

(71) Applicant: CMTE DEVELOPMENT LIMITED, Pinjarra Hills (AU)

(72) Inventors: Barend Jacobus Pienaar, Pinjarra Hills (AU); Paul J.A. Lever, Pinjarra Hills (AU); Terrence James Summers, Callaghan (AU)

(73) Assignee: CMTE DEVELOPMENT LIMITED, Pinjarra Hills (AU)

(21) Appl. No.: 15/534,983

(22) PCT Filed: Dec. 9, 2015
(86) PCT No.: PCT/AU2015/000744

§ 371 Date: Jun. 9, 2017

(30) Foreign Application Priority Data
Dec. 9, 2014 (AU) 2014904981

(51) Int. Cl. G01V 3/10; G01V 3/38

(52) U.S. Cl. CPC G01V 3/10; G01V 3/38

(57) ABSTRACT

A method and system for detecting electrically conductive objects such as tramp metal embedded in a load of mineral ore/earth within a detection space of an earth moving receptacle. A magnetic signal pulse is projected into a detection space of the receptacle by an antennae loop surrounding the detection space. The magnetic response of the system is monitored and analyzed to determine the presence or absence of electrically conductive objects in the loose material within the detection space.

### FIELD OF THE INVENTION

The present invention relates generally to the detection and identification of electrically conductive objects in surrounding, non-electrically conductive material.

The invention has been developed primarily for the detection of tramp metal objects from a load of mined ore and/or soil in a mining production stream as the load enters, and/or exits various earth/ore carrying containers used to transport the ore, and particularly as the ore is collected with an excavator. However, while the invention is described with particular reference to mining applications and the detection of metals, it may also be applied to other industries or applications where the detection of conductive objects embedded in non-conductive material is desirable.

### BACKGROUND OF THE INVENTION

The following discussion of the prior art is intended to facilitate an understanding of the invention and to enable the advantages of it to be more fully understood. It should be appreciated, however, that any reference to prior art throughout the specification should not be construed as an express or implied admission that such prior art is widely known or forms part of common general knowledge in the field.

It is not uncommon in the mining process, that “foreign” objects such as nuts, bolts, pins, drill rods, rock bolts, bits of construction steel, wood or steel stoping and break-offs from mining machinery such as shovel teeth find their way into and contaminate mineral ores. While it is more common that these unwanted materials are found in old mine workings, they can also be present in freshly mined ore.

The unwanted foreign objects are often referred to in the mining industry as “uncrushables” or “tramp metal” and have presented significant and longstanding problems when they find their way into the production stream. That is to say, the comparative hardness and/or shape of such objects can cause serious damage to crushers and other processing machinery, such as belt feeders and conveyor belts if not removed.

In a typical mining production stream, ore from the ore body is dug or collected by an excavator at the mine site and loaded onto a haul truck tray. The haul truck transports the ore to a primary crusher which crushes the ore so it is reduced to a manageable size. The ore may undergo secondary crushing before typically being loaded on to a conveyor system for transport.

When dumped into a primary crusher with a fixed throat size, any tough material which is bigger than the minimum throat gap has the potential to jam the crusher. Anything long and thin such as a drill rod or rock bolt has the potential to make its way through the crusher, into the hopper below and onto the conveyor belt feeder. The nature of the hopper/crusher combination tends to align elongate objects vertically so while the may pass though the crusher without issue, they are orientated to “spear” and potentially split the feeder belt below or worse the main belt.

Normal practice is to position “tramp metal magnets” over the moving conveyors under the crusher to attract and remove any ferromagnetic steels from the product. However, clearly this is too late in the product stream for primary crusher risk mitigation. Thus, it is desirable that all materials other than the required product are removed at some point in advance of the final mills or processing plant. Furthermore this approach will only remove material with magnetic properties. Many electrically conductive materials may be non magnetic.

One solution proposed in US 20110074619 utilises a directionally adjustable radar to detect tramp metal within the load carried by the haul truck. However such devices are complex, unproven and analysis processing time makes the achievement of real-time detection very difficult.

Another system requires the tracking of possible containment objects, such as mechanical shovel teeth to identify when objects are dislodged and may have been lost in the ore stream. However, such solutions are of limited value since clearly there is a significant difference in knowing that an object is missing and positively locating its whereabouts.

It is an object of the present invention to overcome or substantially ameliorate one or more of the deficiencies of the prior art, or at least to provide a useful alternative.

### SUMMARY OF THE INVENTION

Accordingly, in a first aspect the invention provides a method of detecting the presence or absence of electrically conductive objects within a detection space, said method including the steps of:

scanning for electrically conductive objects within the detection space, including the steps of:
generating a magnetic signal in the form of a magnetic pulse within the detection space with magnetic signal generating means; and
monitoring for an induced magnetic response signal within the detection space with magnetic signal monitoring means; and

analysing the induced response signal to determine the presence or absence of electrically conductive objects within the detection space.

In another aspect the invention provides a pulse induction detection system for detecting the presence or absence of electrically conductive objects within a detection space, said system including:

a control unit;

magnetic signal generating means for generating a magnetic signal in the form of a plurality of magnetic pulses within the detection space;

magnetic signal monitoring means for monitoring an induced magnetic response within the detection space; and

a data processor unit for analysing the monitored magnetic response signal to determine the presence of electrically conductive objects within the detection space.

The invention relies on the magnetic signal inducing an electrical current within the electrically conductive object as the object moves through the detection space. The current in turn creates an induced “signal response” magnetic field in the object which may be detected. Consequently the object must comprise electrically conductive matter. Typically, the electrically conductive objects are metal which are embedded or mixed in with the loose ore and earth material. Most commonly the metal is ferromagnetic comprising alloys of iron; however other metals, and in favourable conditions, other electrically conductive materials may also be detected. Real time signal processing methods can reveal the nature of the inclusions from the signature response.

Preferably, the detection space is disposed adjacent an electrically conductive ballast. Preferably the detection space is partially surrounded by an electrically conductive material.

Preferably, the detection space is at least partially within a receptacle, more preferably, the receptacle is formed predominantly of a metal.

Preferably, the electrically conductive objects are embedded in a loose, non electrically conductive material.

In another aspect the invention provides a method of detecting the presence or absence of electrically conductive objects embedded in mining ore and/or earth within an excavator bucket formed predominantly of a metal, the method including the steps of:

providing the excavator bucket for receiving the material, the bucket including an opening for loading and/or unloading the mining ore and/or earth from the bucket;

scanning for electrically conductive objects within the mining ore and/or earth within a detection space of the bucket using pulse induction, including the steps of:
generating a magnetic signal in the form of a magnetic pulse within the detection space of the bucket with magnetic signal generating means; and
monitoring for an induced magnetic response signal within the detection space with magnetic signal monitoring means; and

analysing the induced signal response to determine the presence or absence of electrically conductive objects in the mining ore and/or earth within the detection space.

Preferably, the step of analysing includes the pre-computation of at least one basis function having the expected difference between the presence and absence of electrically conductive objects within the detection space; and cross correlating the basis function with the induced response signal.

Preferably, the basis functions are pre-computed via simulation.

Preferably, the basis functions are measured from an example desired environment.

Preferably, the step of analysing the induced response signal includes isolating a portion of the induced signal response dependant on predetermined signal parameters.

Preferably, the predetermined signal parameters are indicative of signal voltage between threshold values.

Preferably, the magnetic signal generating means and/or the magnetic signal monitoring means includes a transmitting antennae loop surrounding an opening of the receptacle.

Preferably, the transmitting antennae loop is also the receiving antennae loop, the loop defining the detection space.

Preferably, the magnetic signal includes a plurality of magnetic pulses at a frequency range of between around 100 and 1000 Hz.

Preferably, the plurality of signal pulses includes pulses of opposite polarity to reduce magnetisation of the receptacle.

Preferably, the receptacle is formed wholly or predominantly of a metal.

In another aspect the invention provides a method to detect and remove electrically conductive objects embedded in mining ore and/or earth in a mining production stream, the method including the steps of:

digging a load of ore and/or earth with an excavator bucket of an excavator;

during digging, scanning for electrically conductive objects embedded in the load in accordance with the detection method described above; and

selectively diverting the load from the production stream when metal objects are detected in the load.

In another aspect, the invention provides a pulse induction detection system for detecting the presence or absence of electrically conductive objects embedded in a loose, non electrically conductive material within the bucket of a excavator, the system including:

a detector electronics module for generating the magnetic signal and detecting the response signal, the module including:
magnetic signal generating means for generating a magnetic signal in the form of a plurality of magnetic pulses within a detection space of the bucket;
magnetic signal monitoring means for monitoring an induced magnetic response within the detection space; and
a data processor unit for analysing the monitored magnetic response signal to determine the presence of electrically conductive objects in the loose material within the detection space;

a bucket module including at least one antennae loop; and

a control module having a user interface for controlling the system.

Preferably, the user interface module includes indicator means for indicating the presence of electrically conductive objects.

Preferably, the fluid material is mining ore and/or earth.

Preferably, the electrically conductive objects include metal objects or tramp metal.

Preferably, the bucket is formed predominantly of a metal material.

In another aspect, the invention provides an earth moving excavator including:

an excavator bucket, for receiving loads of mining ore and/or earth, the bucket being formed predominantly of a metal and including at least one bucket opening for loading and/or unloading mining ore and/or earth from the bucket;

a pulse induction detection system for detecting the presence or absence of electrically conductive objects within a detection space of the bucket, the system including:
a detector electronics module for generating the magnetic signal and detecting the response signal, the module including:
   magnetic signal generating means for generating a magnetic signal in the form of a plurality of magnetic pulses within a detection space of the bucket;
   magnetic signal monitoring means for monitoring an induced magnetic response within the detection space; and
   a data processor unit for analysing the monitored magnetic response signal to determine the presence of electrically conductive objects in the loose material within the detection space;
a bucket module including at least one antennae loop; and
a control module having a user interface to control the system and display system information.

Preferably, the user interface module includes indicator means for indicating the presence of metal objects.

Preferably, the excavator is a mining shovel.

Preferably, the instrumented bucket includes a bottom wall and a peripheral side wall extending to a peripheral rim defining the bucket opening, the bottom wall and a peripheral side wall surrounding and defining an internal load carrying compartment of the bucket.

Preferably, the side wall includes an inner surface including a slot for receiving the loop.

Preferably, the loop is retained within the slot by a non-metallic and non-conductive keeper.

The term “excavator” is used herein to refer to a wide range of earth moving machinery incorporating a receptacle or bucket. As such the term excavator is intended to include but not be limited to compact excavators, dragline excavators, long reach excavators, steam shovel, power shovel, loaders and dredges.

Similarly the terms “tramp metal” and “uncrushables” are used herein to refer to unwanted foreign objects which may find their way into the mining production stream.

Unless the context clearly requires otherwise, throughout the description and the claims, the words “comprise”, “comprising”, and the like are intended to be construed in an inclusive sense as opposed to an exclusive or exhaustive sense; that is to say, in the sense of “including, but not limited to”.

### BRIEF DESCRIPTION OF THE DRAWINGS

Preferred embodiments of the invention will now be described by way of example only, with reference to the accompanying drawings in which:

FIG. 1 is a schematic view of an exemplary mining production stream;

FIG. 2 is a schematic illustration of a typical electronic process diagram for a pulse induction metal detection system in accordance with the invention;

FIG. 3 is a pictorial illustration of an excavator bucket indicating the approximate mounting position of an antennae loop in accordance with the invention;

FIG. 3A is a detailed, schematic cross section view of an antennae loop mounted within a bucket sidewall in accordance with an embodiment of the invention;

FIG. 3B is a detailed, schematic cross section view of an antennae loop mounted within a bucket sidewall in accordance with an alternative embodiment of the invention;

FIG. 3C is a detailed, schematic cross section view of an antennae loop mounted on the outside wall of a bucket sidewall in accordance with an alternative embodiment of the invention;

FIG. 4 is a pictorial illustration of a shovel dipper having a pulse induction metal detection system provided with separate transmitting and receiving antennae loops in accordance with the invention;

FIG. 5 is a schematic illustration of one form of suitable processing flow within the DSP unit in accordance with the invention;

FIG. 6 is a graphical illustration the difference between two signals from a representative simulation where no noise is present;

FIG. 7 is a detailed graphical illustration of a difference signal structure;

FIG. 8 is a detailed graphical illustration of a resultant difference signal in the presence of noise;

FIG. 9 is a graphical illustration of the data signal of FIG. 6 cross correlated with a noisy input signal, of FIG. 8; and

FIG. 10 is a graphical illustration of one form of suitable basis function, including the expected simulated difference.

### PREFERRED EMBODIMENTS OF THE INVENTION

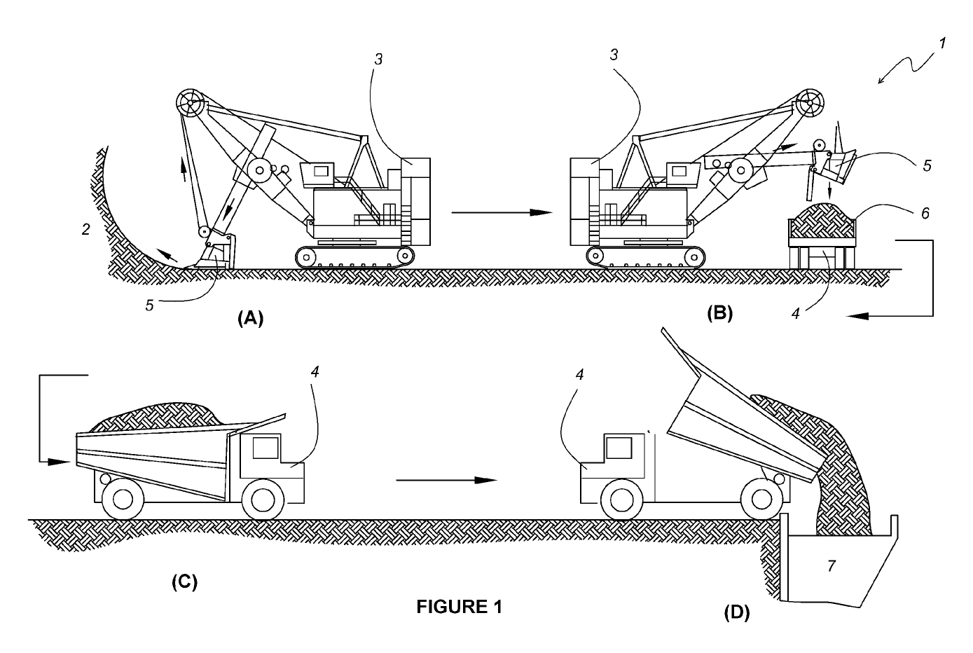

A portion of an exemplary mining production stream 1 is shown in FIG. 1. Ore from an ore body 2 is dug by an excavator 3 and dumped onto a haul truck 4. The excavator 3 may be a mining shovel, a loader or other type of earth moving digger. Either way, the excavator 3 includes a bucket 5 for scooping up loads of ore from the ore body to be dumped into a tray 6 of haul truck 4. The haul truck 4 transports the ore to the primary crusher 7 where it is unloaded into the crusher feeder. Accordingly, the steps (A) thorough (D) shown in FIG. 1 are:

(A) Digging with the excavator to fill the excavator bucket;

(B) Loading the haul truck;

(C) Transporting; and

(D) Unloading at primary crusher.

It will be appreciated that the above production stream is only one example of mining operations. In other production streams, the excavator may load ore into other types of transport means such as a conveyor or rail carriages. In still further variants, an excavator may load ore directly into processing machinery such as a crusher, or the like.

In any event, it will be appreciated that to prevent damage to the primary crusher and conveyors, uncrushable material and in particular tramp metal must be detected and removed from the production stream prior to step (D). However, adding detection means at any of the above stages of the stream presents problems, particularly if the addition of infrastructure is to be minimised.

For instance, while it might be possible to provide a preliminary conveyor and existing “tramp metal magnets” immediately ahead of the crusher and for the specific purpose of detecting and removing tramp metals, it would require the installation of yet another step in processing and more infrastructure. Furthermore, detection and extraction would have to happen almost simultaneously and the size of the uncrushed ore particles would be a hindrance.

In a broad sense, the method and system of the invention involves detecting electrically conductive objects embedded in a load of mineral ore/earth within a detection space of an earth moving receptacle by analysing the magnetic response of the system when subjected to a magnetic signal.

A magnetic signal pulse is projected into a detection space of the receptacle by an antennae loop surrounding the detection space. The magnetic response of the system is monitored with the same or a different antenna loop.

In one form, the method uses pulse induction which recognises that the detection antenna will display slightly different inductance qualities and consequently the decay characteristic of an induced pulse signal will differ depending on whether an electrically conductive object is disposed in the detection space. With appropriate signal processing techniques, the difference may be identified and used determine the presence or absence of a metallic object within the earth moving receptacle.

While the invention may detect any electrically conductive material in the detection space, most commonly the electrically conductive objects are formed from metals. Thus it will be understood that unless stated otherwise, reference to metal objects, or “tramp metal” herein may include any object formed wholly or partly of an electrically conductive material.

From a production process stand-point, if screening for tramp metal is performed during loading of the receptacle or while the bucket is full, it allows the load to be directed as required. For instance, if tramp metal is detected within the load of the receptacle, the load can be selectively rejected from the production stream.

The invention preferably takes advantage of the movement of the electrically conductive objects through the detection space as they are loaded or unloaded into the receptacle. Movement of the conductive objects within the detection space may enhance the response signal and/or provides multiple sample opportunities for detection in the case of a pulsed signal. It also allows the volume of the detection space within the receptacle to be less than the volume of the receptacle.

The system may be fitted to any ore carrying receptacle within the mineral production stream. For instance, the system may be fitted to a receptacle of digging machinery such as the bucket of an excavator, or to a receptacle of transport machinery, such as the tray of a haul truck.

An advantage of fitting the system to the excavator bucket rather than a haul truck tray is that since one excavator commonly services multiple haul trucks, only one detection system is required. Another advantage of screening for tramp metal during the digging stage is that a smaller amount of ore is rejected if and when detected positive indication is made. On the other hand, if screening is undertaken when loading into the haul truck, or during transit, the entire haul truck load must be rejected.

In addition, in some production streams an excavator is used to move ore directly from an ore pile into a crusher, conveyor, rail carriage or the like without requiring haul truck transport.

Therefore, in this embodiment, the invention includes incorporating a electrically conductive object detection system into the excavator bucket 5 so that tramp metal objects may be detected during digging (A) as they enter the excavator bucket along with an ore load. In the case that tramp metal objects are identified within an ore load, the bucket load may be redirected so that the tramp metal objects do not enter the ore production stream.

Simply, when a suspected tramp metal objects is detected in the excavator bucket, the excavator operator is alerted by the system so that the load can be dumped at an alternative location rather than loaded onto a crusher bound haul truck, other transport means or processing machinery such as the crusher.

The system may be fitted to a wide range of excavators including diggers, loaders and mining shovels.

While the invention provides significant advantages in terms of the production processes, there are considerable technical challenges to be overcome to incorporate pulse induction detection into an excavator bucket.

The first difficulty is that while metal detection systems are known, excavator buckets are, at this time in their development, predominantly, if not completely formed of ferromagnetic steel. Clearly then, the monitoring system must be able to distinguish the response signal of a comparatively small unwanted conductive object from any response of a comparative massive electrically conductive ballast, in this case the large ferromagnetic receptacle surrounding the detection space. Current techniques for metal detection which involve monitoring the change in current through the loop with respect to time are acknowledged as being incompatible with such applications.

In the preferred form, the invention utilises pulse induction detection. Pulse induction detection systems direct a short burst or “pulse” of electric current through the antennae loop. This creates a corresponding magnetic field pulse in the object being detected which in turn generates a corresponding much weaker and time delayed return pulse to the receiving antennae loop or magnetometer. This very weak response signal is detected and amplified by a high bandwidth, low noise amplifier (LNA). The amplified signal is digitised and processed with Digital Signal Processing techniques which resolve the response signal to identify the presence of conductive material in the detection space. In one embodiment, only a portion of the response signal is amplified, digitised and processed with Digital Signal Processing techniques. The portion is isolated based on predetermined parameters, such as voltage thresholds.

The pulse is repeated at intervals, generally at between around 100-1000 Hz.

In one embodiment of the invention, the electric current “pulse” is allowed to grow to a fixed value in the antennae loop. It is then abruptly switched off, resulting in a high voltage (for instance, of the order of 2000 volts) being induced across the terminals of the loop. This induced “response” voltage will be polarized in the opposite direction to the original applied voltage. The loop is closed electrically by means of a burden resistance, such that the energy stored in the loop dissipates at an exponential rate. The decay characteristic of the dissipating energy or response signal, will differ depending on the induction characteristics of the loop and particularly, whether an electrically conductive object is disposed in its vicinity. It is not until the dissipating response signal across the burden resistance decays to a predetermined value (for instance, about 0.7 volts) that the signal is amplified and processed.

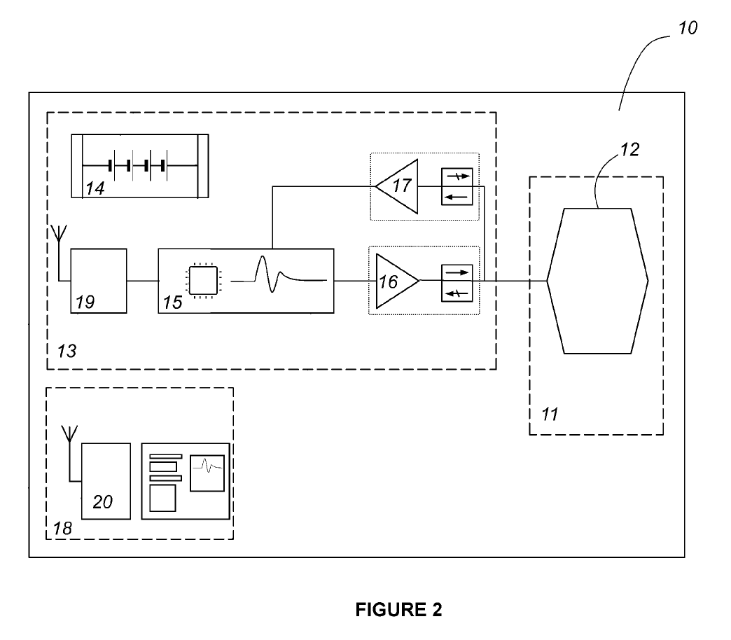

By way of example, a schematic electronic circuit for a pulse induction detection system 10 is shown in FIG. 2. The system may be divided into three modules. The bucket system module 11 includes the antennae loop or magnetometer 12, mounted to surround the detection space or opening to the receptacle or bucket. The antennae 12 which may comprise a plurality of coil windings surrounding the detection space (for instance 5-30 windings), is connected to a metal detector electronics module 13 for generating the magnetic signal and detecting the response signal. The electronics module 13 includes a power supply 14, connected to a digital processor unit 15 including digital signal processor (DSP). A power transmitter 16 delivers the electric current pulse to the antennae loop to generate a corresponding electromagnetic field pulse within the antennae.

A response electromagnetic signal detected is amplified by a low noise amplifier (LNA) 17 connected to the antennae. This signal is fed back to the DSP 15 to be filtered and analysed. A control module 18 including a user interface in the operators cab is provided to control the system and display system information to the digger operator.

It should be noted that the above described system is intended to be exemplary of a pulse induction detection system. The invention is not limited to the particular configuration of the system and modules described. Various components of the system may be replaced or reconfigured without departing from the scope of the invention.

For instance, in one embodiment, the invention proposes the wireless transmission of data 19, 20 to and from the user interface and control module 18 in the operator's cab so that the electronics module 13 and the bucket module 11 may be mounted to the excavator bucket/arm and the user interface module connected wirelessly thereto.

An additional problem with locating the system within an excavator bucket is that being a ferromagnetic material, the steel of the bucket has the propensity to become magnetised when repeatedly exposed to magnetic fields. That is to say, eventually the steel bucket will build up a semi permanent magnetic bias aligned with magnetic field pulses projected by the loop. Even a small magnetic bias can affect the detection process by concealing the induced magnetic fields of the tramp metal objects within the bucket.

In order to address this problem, the invention includes a method for demagnetising steel by means of de-gaussing whereby the magnetic field is intermittently reversed in polarity by reversing the current in the antennae loop. Preferably the non-reversed field is balanced by the reversed field thereby eliminating magnetic bias build-up. Clearly one method for balancing reversed and non-reversed fields is to apply pulses which alternate in polarity. In this regard, as illustrated in FIG. 2, the loop is driven by an H bridge circuit such that the current in the antennae loop alternates between pulses. In turn, the corresponding magnetic field pulses generated by the antennae loop alternate in magnetic polarity thus neutralising any tendency for the steel to become magnetised.

In the embodiment illustrated in schematic FIG. 2, the antennae loop 12 is used both to project the magnetic signal and detect the magnetic response signal. However, in other embodiments, one or more separate transmitting and receiving antennae loops are provided. In further embodiments, one or more magnetometers or SQUID's in an array may be used in order to detect the return magnetic response, rather than, or in addition to the loop.

Another significant problem to address when installing a pulse induction detection system into an excavator bucket relates to practical installation. That is to say, excavator buckets are normally formed of steel because it is an extremely tough material able to withstand the harsh environments and loads of earth excavation. On the other hand, the antennae loop and associated electronics are a comparatively light weight and fragile component.

In order to protect the loop, appropriate shielding must be provided. However, the loop antennae requires a non metallic window to allow the magnetic field to penetrate to the centre of the bucket. Furthermore, a “metal free zone” must exist around the coil.

The invention therefore provides a means for mounting and shielding an antennae loop or a multitude of loops around either the inside or the outside of the bucket.

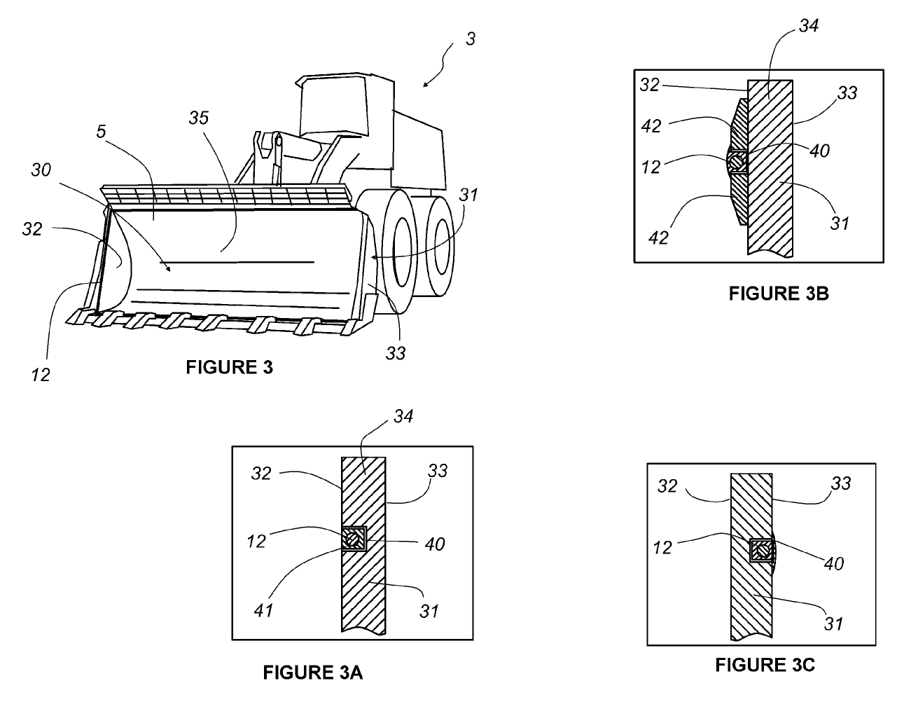

In one form of the invention, the bucket is specifically designed for the incorporation of a loop antennae. Referring to FIG. 3, an excavator or loader 3 includes bucket 5 having a bottom wall 30 and a peripheral side wall 31 having inner and outer surfaces 32 & 33. The bottom wall and side walls surrounding and defining an internal load carrying compartment of the bucket for holding and containing earth and/or mineral ore or other bulk material. The side wall 31 includes a peripheral rim 34 defining a bucket opening 35 through which material may be loaded into or unloaded from the bucket.

Preferably, the loop 12 is mounted at or near the peripheral rim 34 of the side wall 31 so that the detection space is at the bucket opening and the material must pass through the detection space in order to enter or leave the bucket.

Referring to detail FIG. 3A of the bucket shown in FIG. 3, the bucket is designed and manufactured with one or more mounting slots 40 in the inner wall 32 of the bucket side-wall 31. The mounting slot 40 is formed as a channel in the sidewall.

The antennae loop 12 is fixed and retained within the slot 40, by a non-metallic and non-conductive keeper 41. The keeper shields the loop from impacts and abrasion of the ore being loaded by the bucket. The exposed surface of the keeper is generally flush or substantially flush with the surface of the inner wall thereby minimising exposure of both the loop, and the keeper.

The keeper may be formed of any non-conductive material, such as abrasion resistant plastics or rubbers, ceramics, ferrites and/or composites. The keeper may be formed as a single part or as multiple parts. It may be fixed within the slot by attachment means including adhesives, threaded fasteners or snap fitting inter-engaging formations.

In a further embodiment, the invention provides a system for retrofitting existing excavator buckets. However, in such cases, it may not be possible to provide a mounting slot in the inner wall. FIG. 3B displays a detailed view of a bucket side wall 31 retrofitted with an antennae loop 12. In the figure, parallel spaced protection strips 42 are attached to the inner wall of the bucket to form mounting slot 40 there-between. The strips may be formed of steel and welded or bolted to the bucket wall. The strips may include an inclined face to deflect material and earth over the slot.

In another form shown in detail FIG. 3C, the antennae loop is disposed on the outside wall 33 of the bucket wall thereby requiring less protection. In this embodiment, the bucket wall, at least adjacent the loop may be formed of a non-ferrous metal material so as not to interfere with the magnetic field. In another embodiment, a circumferential ring section of the bucket wall may be insulated from the rest of the bucket wall and thereby form the loop.

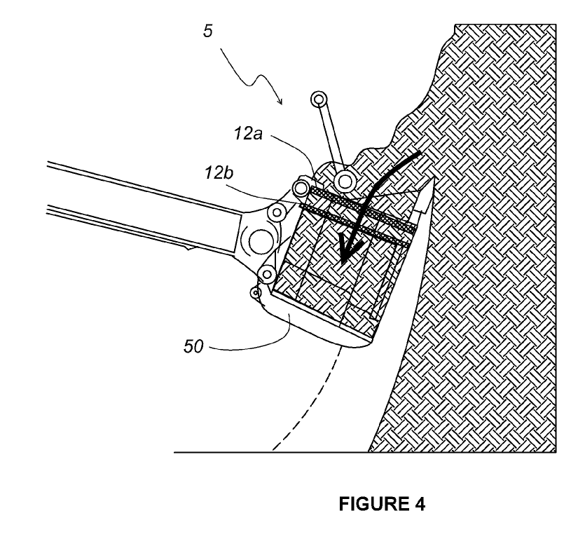

Some excavators, such as mining shovel dipper buckets shown in FIG. 4, may include an open-able bottom wall 50 to allow material in the bucket to be unloaded through the bottom. In this embodiment shown, a shovel dipper bucket 5 is to be fitted with a transmitting antennae loop 12a for projecting the pulsed magnetic field and a separate receiving loop 12b for monitoring the returned signal.

FIG. 4 also displays the bucket during digging whereby the earth and/or mineral ore pass through the antennae loops 12a and 12b and into the bucket.

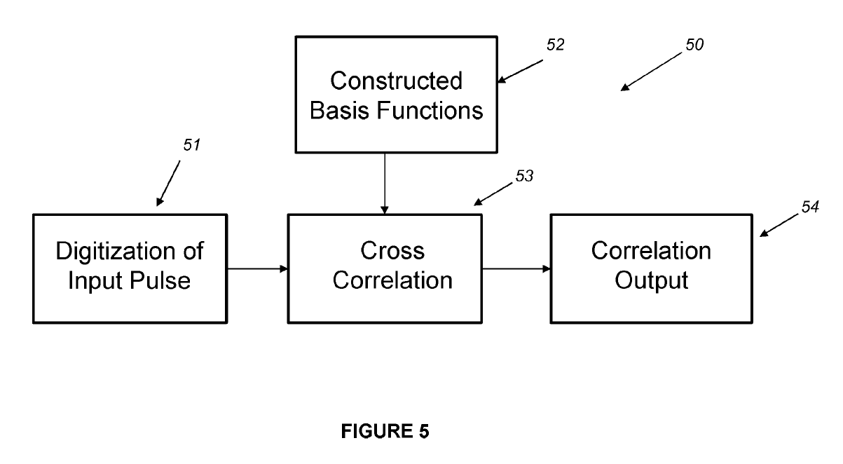

Turning now to FIG. 5, there is illustrated one form of suitable processing flow within the DSP unit for the identification of differences indicating the presence of tramp material.

In accordance with modern DSP capabilities, it is assumed that a sample rate of at least 1 MHz is provided with a 12 bit sample size.

The processing flow 50 illustrated in FIG. 5 includes digitization of the monitored input response signal 51, which is cross correlated 53 with some pre-constructed basis functions 52 so as to produce a correlated output 54. The basis functions are those constructed to simulate the effects of magnetic changes are a consequence of insertion of conductive objects. The basis functions are ideally constructed by simulation, however, calibration basis functions could also be used.

The cross correlation acts to assist in the identification of any structured signal out of the background noise inherent in the input signal.

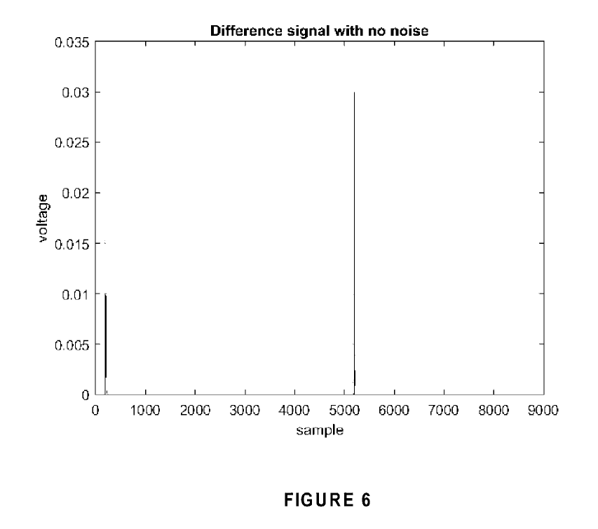

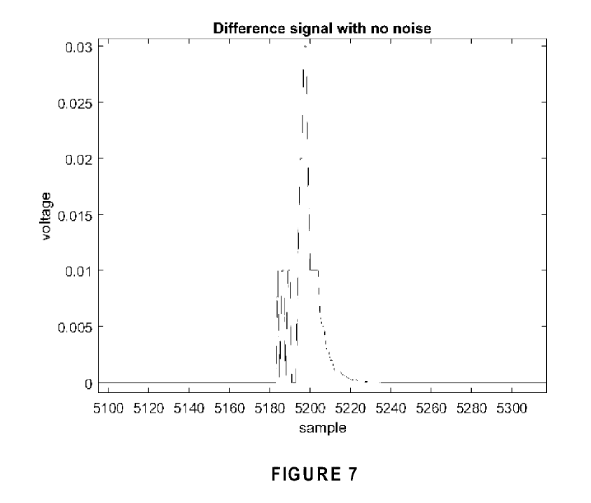

For example, FIG. 6 illustrates the difference between two response signals from a representative simulation where no noise is present and the inductance is changed by about 0.1%. The difference signal structure is further illustrated in FIG. 7 which shows a zoomed in portion of the signal at 12 bit resolution sampled at 1 MHz.

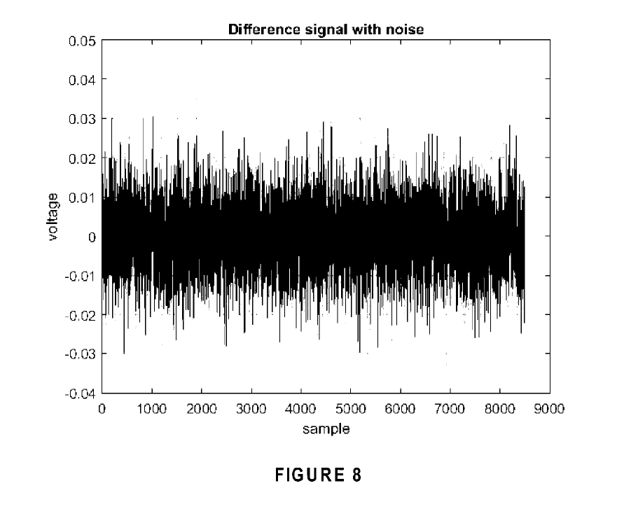

However, in the presence of noise, (e.g. 20 mV peak Gaussian), such a signal is likely to be swamped by the noise. FIG. 8 illustrates the resultant difference signal in the presence of noise.

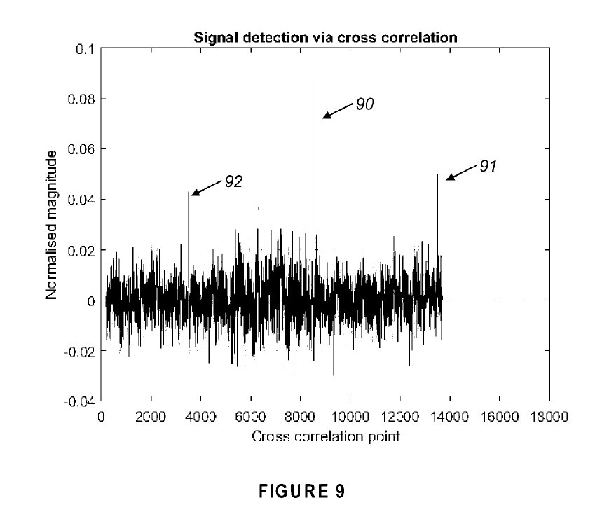

Through the utilisation of cross correlation of the constructed basis function and the noisy input response signal, a small change in inductance can be detected. FIG. 9 illustrates on example result illustrating the example cross correlation peak 90. Using such techniques allows us to detect a signal in the presence of excessive noise. The example of FIG. 9 illustrates the image of FIG. 6 cross correlated with a noisy input signal, of FIG. 8.

The three peaks 90, 91 and 92 occur because the convolution convolves two phase separated basis functions with a signature with two like signatures in it.

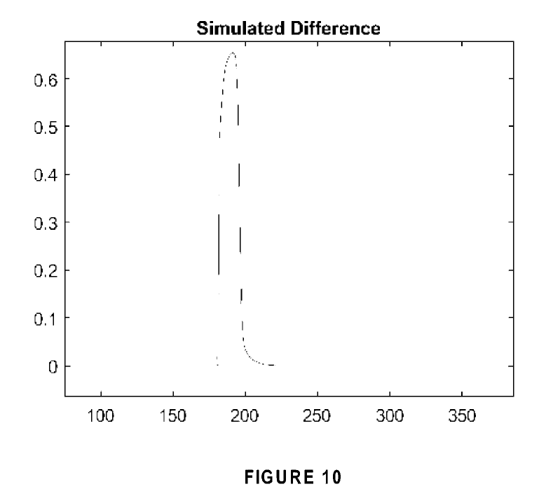

FIG. 10 illustrates one form of suitable basis function, including the expected simulated difference, for use with the convolution.

Improving the sampling rate (e.g. 3 MHz), sampling fidelity or reducing the noise floor will also lead to improved results. Further, the temperature stability of the sensor is also desirable.

It will be appreciated that the present invention provides a system and method for detecting electrically conductive objects and tramp metal in a mining production stream. The system can equally be retrofitted to existing excavators as it can be installed into new purpose built bucket designs. It requires no other substantial additional infrastructure.

It will be appreciated that in these and other respects, the invention represents a practical and commercially significant improvement over the prior art.

Unless specifically stated otherwise, as apparent from the following discussions, it is appreciated that throughout the specification discussions utilizing terms such as “processing,” “computing,” “calculating,” “determining”, “analysing” or the like, refer to the action and/or processes of a computer or computing system, or similar electronic computing component, that manipulate and/or transform data represented as physical, such as electronic quantities into other data similarly represented as physical quantities.

In a similar manner, the term “processor” or Digital Signal Processor (DSP) may refer to any device or portion of a device that processes electronic data, e.g., from registers and/or memory to transform that electronic data into other electronic data that, e.g., may be stored in registers and/or memory. A “computer”, “computing machine” or a “computing platform” may include one or more processors. The term “Digitise” may refer to the process of converting an analogue signal into a digital number stream capable of manipulation by a DSP. The sequential instructions given to the processor is generally known as software.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by the processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B, should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1.-54. (canceled)

55. A method of detecting the presence or absence of electrically conductive objects within a detection space, said method including the steps of:
(a) pulsing a conductive loop around the detection space;
(b) sampling the electromagnetic decay response to the pulse;
(c) cross correlating the sampled decay response with a pre-constructed basis function, the pre-constructed basis function simulating the effects of insertion of conductive objects into the detection space, to produce a correlated output; and
(d) analyzing the correlated output for magnitude peaks to provide an indication of the presence or absence of electrically conductive objects within the detection space.

56. The method as claimed in claim 55 wherein said pre-constructed basis function is pre-constructed by simulating the difference signal between placing a conductive object in the detection space and removing the conductive object from the detection space.

57. The method as claimed in claim 55 wherein said pre-constructed basis function is pre-constructed by simulating the effects of placing a conductive object in the detection space.

58. The method as claimed in claim 55 wherein said simulation simulates the inductive change of placing a conductive object within said detection space.

59. The method as claimed in claim 55 wherein said pre-constructed basis function is pre-constructed by measuring the effects of placing a conductive object in the detection space.

60. The method as claimed in claim 59 wherein said measuring the effects of placing a conductive object in the detection space includes the presence of noise.

61. The method as claimed in claim 55 wherein the detection space is partially surrounded by electrically conductive materials.

62. The method as claimed in claim 55 wherein the detection space is at least partially within a receptacle formed predominantly of a metal.

63. The method as claimed in claim 55 wherein the step of pulsing a conductive loop around the detection space includes electrically energizing said loop with pulses at a frequency range of between around 100 and 1000 Hz.

64. The method as claimed in claim 63 wherein the pulses are alternated in polarity.

65. The method as claimed in claim 62 wherein the receptacle is an excavator bucket, said bucket including an opening for loading and/or unloading mining ore and/or earth from the bucket.

66. The method as claimed in claim 65 wherein the conductive loop surrounds the opening of the excavator bucket.

67. A method to detect and remove electrically conductive objects embedded in mining ore and/or earth in a mining production stream, said method including the steps of:
digging a load of ore and/or earth with an excavator bucket of an excavator;
during digging, scanning for electrically conductive objects embedded in the load in accordance with the method of claim 65; and
selectively diverting the load from the production stream when metal objects are detected in the load.

68. A pulse induction detection system for detecting the presence or absence of electrically conductive objects within a detection space, said system including:
a control unit;
signal generating means for pulsing a conductive loop around the detection space;
monitoring means for monitoring the electromagnetic decay response to the pulse; and
a data processor unit for cross correlating the sampled decay response with a pre-constructed basis function, the pre-constructed basis function simulating the effects of insertion of conductive objects into the detection space, to produce a correlated output; and analyzing the correlated output for magnitude peaks to provide an indication of the presence or absence of electrically conductive objects within the detection space.

69. The system as claimed in claim 68 wherein said pre-constructed basis function is pre-constructed by simulating the difference signal between placing a conductive object in the detection space and removing the conductive object from the detection space.

70. The system as claimed in claim 68 wherein said pre-constructed basis function is pre-constructed by simulating the effects of placing a conductive object in the detection space.

71. The system as claimed in claim 69 wherein said simulation simulates the inductive change of placing a conductive object within said detection space.

72. The system as claimed in claim 68 wherein said pre-constructed basis function is pre-constructed by measuring the effects of placing a conductive object in the detection space.

73. The system as claimed in claim 72 wherein said measuring the effects of placing a conductive object in the detection space includes the presence of noise.

74. The system as claimed in claim 68 wherein the detection space is partially surrounded by an electrically conductive material.

75. The system as claimed in claim 74 wherein the detection space is at least partially within a receptacle formed predominantly of a metal.

76. The system as claimed in claim 75 wherein the loop is disposed at or adjacent a rim of the receptacle, said rim defining the receptacle opening.

77. The system as claimed in claim 75 wherein the receptacle is an excavator bucket, said bucket including an opening for loading and/or unloading mining ore and/or earth from the bucket.

78. An earth moving excavator including a pulse induction detection system as claimed in claim 77.

79. The excavator as claimed in claim 78 wherein the bucket includes a bottom wall and a peripheral side wall extending to a peripheral rim defining said bucket opening, said bottom wall and a peripheral side wall surrounding and defining an internal load carrying compartment of the bucket.

80. The excavator as claimed in claim 79 wherein the side wall includes an inner surface including a slot for receiving said loop.

81. The excavator as claimed in claim 80 wherein the loop is retained within said slot by a non-metallic and non-conductive keeper.

82. A method of detecting the presence or absence of electrically conductive objects within a detection space, said method including the steps of:
(a) sensing the magnetic field intensity of a detection space;
(b) cross correlating the magnetic field intensity with a pre-constructed basis function, the pre-constructed basis function simulating the effects of insertion of magnetic or conductive objects into the detection space, to produce a correlated output; and
(c) analyzing the correlated output for magnitude peaks to provide an indication of the presence or absence of magnetic or electrically conductive objects within the detection space.
